(19) United States
(12) Patent Application Publication
(10) Pub. No.: US 2018/0040006 A1
(43) Pub. Date: Feb. 8, 2018

(54) METHOD FOR GENERATING WEBPAGE ON BASIS OF CONSUMER BEHAVIOR PATTERNS AND METHOD FOR UTILIZING WEBPAGE

(71) Applicant: SAMSUNG SDS CO., LTD., Seoul (KR)

(72) Inventors: Jin-Gyeom KIM, Seoul (KR); Won-Dong LEE, Seoul (KR)

(73) Assignee: SAMSUNG SDS CO., LTD., Seoul (KR)

(21) Appl. No.: 15/550,648

(22) PCT Filed: Dec. 23, 2015
(86) PCT No.: PCT/KR2015/014159

§ 371 Date: Aug. 11, 2017

(30) Foreign Application Priority Data
Feb. 11, 2015 (KR) 10-2015-0021034

(51) Int. Cl. G06Q 30/02; G06F 17/30

(52) U.S. Cl. CPC G06Q 30/0201; G06F 17/30106; G06Q 30/0276; G06Q 30/0255; G06Q 30/0261; H04L 67/146

(57) ABSTRACT

Disclosed herein is a method for generating a web page based on a consumer's behavior pattern. The method includes: receiving information indicating that a consumer carrying a first terminal device assigned an identifier has entered a zone of a store when the consumer entered the zone; receiving a log record associated with the consumer's behavior pattern via a second terminal device installed in a zone of the store; storing the log record in a folder corresponding to the identifier assigned to the first terminal device; and generating a web page based on the log record.

### TECHNICAL FIELD

The present disclosure relates to a method for generating a web page based on a consumer's behavior pattern and for utilizing it. More specifically, the present disclosure relates to a method for generating a web page based on a consumer's behavior pattern and for utilizing it, by which information on the location of a consumer, items that the consumer is interested in and the like are received from a terminal device issued to the consumer and a terminal device installed in the store, and information on the items that the consumer is interested in can be provided as a web page based on the received information.

### BACKGROUND ART

A variety of attempts have been made to track consumers' behavior in a particular store and to build a database for advertisement or promotion of items.

For example, there has been proposed an approach that consumers are encouraged to install an application on their smart phones, and location information on the consumers in a store is received, to thereby determine what kind of items the consumers are interested in based on the received location information.

The above-described approach, however, essentially requires consumers to install the application on their smart phone, and thus cost is incurred to encourage the consumers to install the application. In addition, customers may not be happy with collecting their personal information.

Under the circumstances, what is required is a method for efficiently delivering information on items that consumers are interested in by analyzing the consumers' behavior patterns in a store without requiring them to install any additional application on their various types of mobile devices.

### DISCLOSURE

### Technical Problems

Aspects of the present disclosure provide a method for generating a web page based on consumers' behavior patterns and utilizing it, by which the behavior patterns in a store can be analyzed without collecting the consumers' personal information.

Aspects of the present disclosure also provide a method for generating a web page based on consumers' behavior patterns and utilizing it, by which information on items that the consumers are interested in can be efficiently provided based on results of analyzing the consumer's behavior patterns in a store.

This and other aspects, embodiments and advantages of the present disclosure will become immediately apparent to those of ordinary skill in the art upon review of the Detailed Description and Claims to follow.

### Technical Solutions

According to an aspect of the present disclosure, there is provided a method for analyzing a consumer's behavior pattern, including: receiving information indicating that a consumer carrying a first terminal device assigned an identifier has entered a zone of a store when the consumer entered the zone; receiving a log record associated with the consumer's behavior pattern via a second terminal device installed in a zone of the store; storing the log record in a folder corresponding to the identifier assigned to the first terminal device; and generating a web page based on the log record.

The receiving the information may include: receiving an entry information message comprising the identifier assigned to the first terminal device; and generating the folder corresponding to the identifier.

The entry information message may include at least one of: the identifier assigned to the first terminal device, a time when the consumer carrying the first terminal device enters a zone of the store, and location information on the zone of the store.

The log record associated with the consumer's behavior pattern may include the identifier assigned to the first terminal device carried by the consumer.

The log record associated with the consumer's behavior pattern may include at least one of: information on items searched by the consumer via the second terminal device, the consumer's history of consulting, a brochure opened by the consumer, an inquiry input by the consumer, and a staff's profile who consulted with the consumer.

The storing the log record may include: searching for a folder corresponding to the identifier included in the log record; and storing the log record in the folder corresponding to the identifier.

The generating the web page may include: receiving a request to generate a web page including the identifier; and generating the web page by using the log record stored in the folder corresponding to the identifier.

The receiving the request may include: receiving the identifier from a manager's terminal device, the identifier being transmitted as the first terminal device is brought into contact with the manager's terminal device; and generating a web page by using the log record stored in the folder corresponding to the identifier to provide the web page to the manager's terminal device.

The method may further include: transmitting a uniform resource locator (URL) used for accessing the generated web page to the consumer's mobile device.

The generating the web page may include: receiving information indicating that the consumer carrying the first terminal device has entered a zone of the store, from a third terminal device installed in the zone; generating the web page based on the log record associated with the consumer's behavior pattern received via the second terminal device; and providing the generated web page to the third terminal device.

According to another aspect of the present disclosure, there is provided a server comprising: at least one processor; a memory where a computer program executed by the processor is loaded; and storage where at least one folder corresponding to an identifier assigned to a first terminal device carried by a consumer and a log record included in the folder are stored, wherein the computer program, when executed, causes the server to perform the operations of: receiving information indicating that the consumer carrying the first terminal device assigned the identifier has entered a zone of a store when the consumer entered the zone; receiving a log record associated with the consumer's behavior pattern via a second terminal device installed in a zone of the store; storing the log record in a folder corresponding to the identifier assigned to the first terminal device; and generating a web page based on the log record.

According to another aspect of the present disclosure, there is provided a computer program stored in a storage medium, the program, when executed, causing a computing device to perform the operations of: receiving information indicating that a consumer carrying a first terminal device assigned an identifier has entered a zone of a store when the consumer entered the zone; receiving a log record associated with the consumer's behavior pattern via a second terminal device installed in a zone of the store; storing the log record in a folder corresponding to the identifier assigned to the first terminal device; and generating a web page based on the log record.

According to another aspect of the present disclosure, there is provided a system for generating a web page based on a consumer's behavior pattern, including: a first terminal device assigned an identifier and issued to a consumer; a second terminal device installed in a zone of a store; and a server configured to receive a log record from the second terminal device to generate a web page, wherein the second terminal device is configured to transmit information indicating that the consumer carrying the first terminal device has entered a zone when the consumer enters the zone, and to transmit the log record associated with the consumer's behavior pattern to the server, and wherein the server is configured to store the received log record in a folder corresponding to the identifier assigned to the first terminal device, and to generate a web page based on the stored log record.

### Advantageous Effects

According to an exemplary embodiment of the present disclosure, by analyzing consumers' behavior patterns in the store by using the terminal devices issued to the consumers and providing the information on items to the consumers based on it, it is possible to provide information customized for the consumers without requiring any troublesome step of installing an additional application on the consumers' mobile devices.

### BRIEF DESCRIPTION OF DRAWINGS

FIG. 1 is view showing a system for illustrating a method of generating a web page based on consumers' behavior patterns according to an exemplary embodiment of the present disclosure;

FIG. 2 is a view for illustrating a process of generating a web page using log records stored in the server to provide it to a user according to an exemplary embodiment of the present disclosure;

FIG. 3 is a view for illustrating a method for generating a web page based on log records stored in a server and providing it to a consumer according to yet another exemplary embodiment of the present disclosure;

FIG. 4 is a view for illustrating a method for providing a web page including information related to the items that a consumer is interested to the consumer in real-time according to an exemplary embodiment of the present disclosure;

FIGS. 5 to 7 are views for illustrating a method for generating log records associated with consumers' behavior, sorting and storing them for each of the consumers, and generating a web page reflecting the consumer's preference based on it;

FIG. 8 is a flowchart for illustrating the above-described method for generating a web page based on a consumer's behavior pattern;

FIG. 9 is a flowchart for illustrating an operation for generating a web page by a server based on a consumer's behavior pattern according to an exemplary embodiment of the present disclosure; and

FIG. 10 is a functional block diagram for illustrating a server for generating a web page and providing it to a consumer according to the above-described embodiment.

### BEST MODES FOR CARRYING OUT THE INVENTION

Hereinafter, exemplary embodiments of the present disclosure will be described in detail with reference to the accompanying drawings. Advantages and features of the present disclosure and methods to achieve them will become apparent from the descriptions of exemplary embodiments hereinbelow with reference to the accompanying drawings. However, the present invention is not limited to exemplary embodiments disclosed herein but may be implemented in various different ways. The exemplary embodiments are provided for making the disclosure of the present invention thorough and for fully conveying the scope of the present invention to those skilled in the art. It is to be noted that the scope of the present invention is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Unless specifically mentioned otherwise, a singular form may include a plural form in the present specification. Throughout this specification, the word “comprise” and variations such as “comprises” or “comprising,” will be understood to imply the inclusion of stated constituents, steps, operations and/or elements but not the exclusion of any other constituents, steps, operations and/or elements.

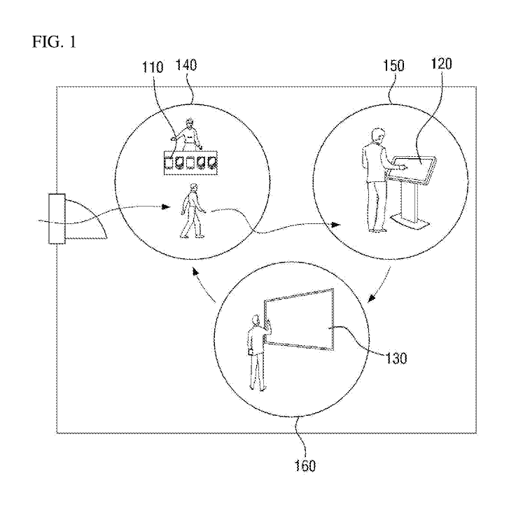

FIG. 1 is view showing a system for illustrating a method of generating a web page based on consumers' behavior patterns according to an exemplary embodiment of the present disclosure.

In this exemplary embodiment of the present disclosure, a consumer enters a store where items are displayed, receives a terminal device at the information desk, and then looks around the store to see information on each of the items.

When a consumer enters a first zone 140 where the information desk is located, a first terminal device 110 assigned an identifier is issued to the consumer. Specifically, a staff in the store may give the first terminal device 110 to the customer and may transmit an initiation message indicating that the first terminal device 110 is issued to the consumer so that it is used, to a server.

For example, the staff may transmit information on the first terminal device 110 to be issued to the consumer via a desktop PC installed at the information desk, or may bring the first terminal device 110 into contact with a contact terminal installed at the information desk to transmit an initiation message to the server.

Alternatively, the first terminal device 110 issued to the consumer may transmit the initiation message to the server.

The initiation message transmitted to the server may include an identifier assigned to the first terminal device 110, an initiation time of the first terminal device 110, and the like.

Thereafter, when the consumer carrying the first terminal device 110 moves to another zone of the store, i.e., a second zone 150, a signal indicating that the consumer has entered the second zone 150 is transmitted to the server. The signal may be transmitted when the consumer brings the first terminal device 110 into contact with a second terminal device 120 installed in the second zone 150 or, a beacon may be installed in the second zone 150 so that it recognizes that the consumer carrying the first terminal device 110 has entered the second zone 150.

When the consumer who entered the second zone 150 searches for the information on an item displayed in the second zone 150 via the second terminal device 120 installed at the zone, the log record of the item searched by the consumer is transmitted to the server together with the identifier assigned to the first terminal device 110.

For example, information indicating that the consumer searched for the information on an item A via the second terminal device 120, or a log record indicating that the item A has been compared with an item B may be transmitted to the server.

The server receives the log record and then stores the log record in a folder corresponding to the first terminal device 110 issued to the consumer.

Specifically, the log record may include an image of the item that the consumer searched by using a terminal device installed in the store, a video clip relating the item and various information on the item.

Likewise, when the consumer carrying the first terminal device 110 moves from the second zone 160 to a third zone 160, the information indicating that the consumer has moved to the third zone 160 is transmitted to the server, and then the information on the item that the consumer searched by using the terminal device installed in the third zone 160 is transmitted to the server together with the identifier of the first terminal device 110.

After the consumer looked around all the items displayed in the store, the consumer comes back to the first zone 140 for consultation with the staff. Then, the consumer brings the first terminal device 110 received from the staff into contact with the staff's terminal device, such that a web page composed of the information on the items searched by the user in the store is provided to the consumer.

Specifically, the web page provided to the consumer may be generated using log records that reflect the consumer's behavior in the store.

A method of generating a web page using log records stored in the server to provide it to the consumer will be described in detail below.

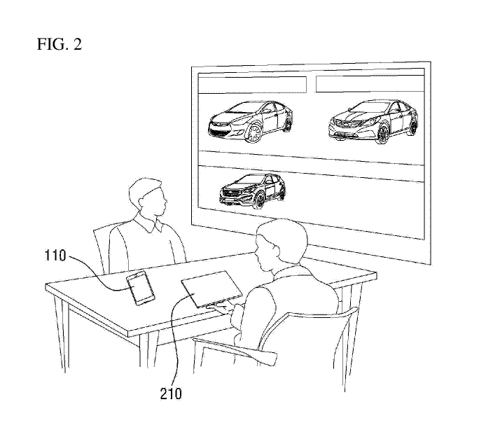

FIG. 2 is a view for illustrating a process of generating a web page using log records stored in the server to provide it to a user according to an exemplary embodiment of the present disclosure.

When the consumer brings the first terminal device 110 received from a staff when she/he entered the store into contact with the staff's terminal device 210, the identifier assigned to the first terminal device 110 is transmitted to the server via the staff's terminal device.

The server receives the identifier assigned to the first terminal device 110, and then generates a web page by using the log record stored in the folder corresponding to the identifier.

In the folder of the server, the log records related to the consumers' behavior in the store are stored, such as the information on the items searched by the consumers in the store, and the images or the video clips of the items. Accordingly, by generating a web page based on the log records, the information on the items that the user is interested in can be efficiently provided.

For example, if the consumer searched for information on the item A in the store, she/he may download a brochure related to the item A or may receive a web page composed of the image or video clip of the item A.

Alternatively, if the user searched information on a plurality of items in the store, a web page composed of results of comparing and analyzing the items may be generated and provided to the user.

As described above, by analyzing consumers' behavior patterns in the store by using the terminal devices issued to the consumers and providing the information on items to the consumers based on it, it is possible to provide information customized for the consumers without requiring any troublesome step of installing an additional application on the consumers' mobile devices.

In the above-described embodiment, the customer brings the first terminal device 110 into contact with the staff's terminal device 120 to receive a web page generated from the server. However, it is to be understood that this is merely illustrative. For example, a web page to be provided to the consumer may be generated in the server in different ways.

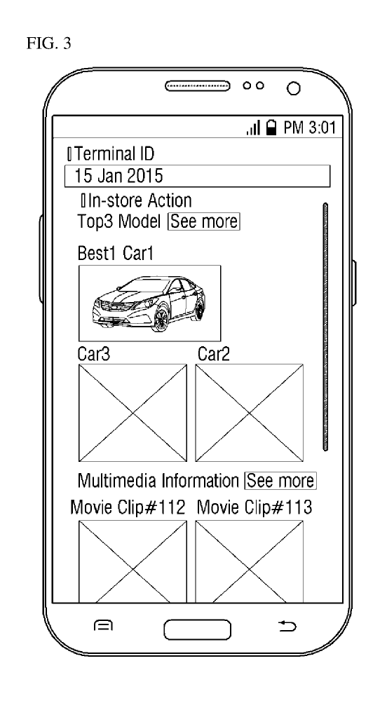

FIG. 3 is a view for illustrating a method for generating a web page based on log records stored in a server and providing it to a consumer according to yet another exemplary embodiment of the present disclosure.

A consumer looked around items in the store while carrying the first terminal device 110 and returns the first terminal device 110 to the staff after searching for the displayed items. Then, a URL may be provided to the consumer, which may be used for accessing a web page generated using log records stored in one of the folders stored in the server that corresponds to the terminal device 110.

Alternatively, when the consumer brings the first terminal device 110 into contact with her/his mobile device, the identifier of the first terminal device 110 may be transmitted to the mobile device over wireless communications such as NFC and RF, such that the mobile device may send a request to generate a web page including the identifier to the server.

The server receiving the request including the identifier may generate a web page based on the log record stored in the folder in the server corresponding to the identifier and provide a URL to the user's mobile device for accessing the web page.

For example, the consumer may receive the URL (Uniform Resource Locator) of the web page in the form of a short message service (SMS).

When the consumer clicks a URL link in a text message, the web page corresponding to the first terminal 110 carried by the consumer is loaded, such that the screen shown in FIG. 3 may be displayed on the mobile device.

The web page loaded and displayed on the mobile device carried by the consumer may include detailed information, images and video clips of the items searched by the consumer in the store.

In the above-described embodiment, a web page including the information related to the items that the consumer is interested in is provided after the consumer looks around all the items in the store and then returns the first terminal device 110 to a staff. However, this is merely illustrative. For example, a web page including the information related to the items the consumer searched for may be provided in real-time.

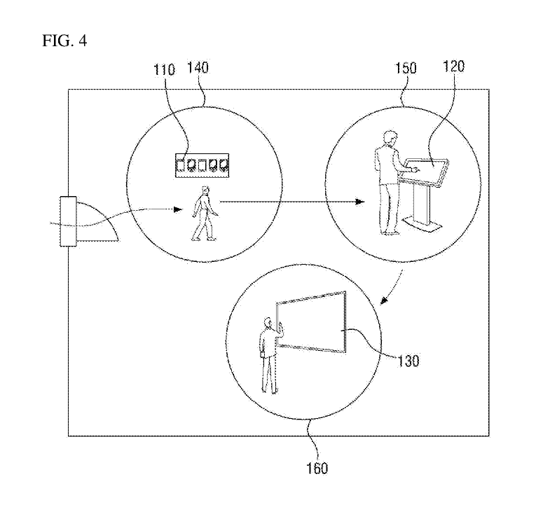

FIG. 4 is a view for illustrating a method for providing a web page including information related to the items that a consumer is interested to the consumer in real-time according to an exemplary embodiment of the present disclosure.

In this embodiment, a first terminal device 110 is issued to a consumer in a first space 140 in a store, and the consumer moves to a second space 150 and a third space 160 while searching for items.

In addition, in each of the divided spaces, displayed items, as well as terminal devices 120 and 130 for searching for information on the displayed items are placed.

When the consumer carrying the first terminal device 110 enters the second zone 150, information indicating that the consumer has entered the zone is transmitted to the server. Subsequently, the log information on the items searched by the consumer via the second terminal device 120 placed in the second zone 150 is transmitted to the server along with the identifier of the first terminal device 110.

The log information transmitted to the server is stored in a folder corresponding to the identifier of the first terminal device 110 carried by the consumer and used to generate a web page providing information on the items to the consumer.

When the consumer leaves the second zone 150 to enter the third zone 160, a signal is transmitted to the server, which indicates that the consumer carrying the first terminal device 110 has entered the third zone 160.

On the third terminal device 130 installed in the third zone 160, the information on the items searched by the consumer in the second zone 150 may be presented first or information that compares the items searched by the consumer in the second zone 150 with items displayed in the third zone 160 may be displayed.

For example, the consumer entering the third zone 160 may bring the first terminal device 110 she/he carries into contact with the third terminal device 130 installed in the third zone 160.

When the consumer brings the first terminal device 110 she/he carries into contact with the third terminal device 130, the identifier assigned to the first terminal device 110 is transmitted to the server, thereby transmitting a signal indicating that the consumer has entered the third zone 160.

Upon receiving it, the server transmits the log record stored in the folder corresponding to the first terminal device 110 to the third terminal device 160, such that the information on the items searched by the consumer in the second zone 150 is displayed on the third terminal device 130.

For example, if the consumer searched for information on the item A in the second zone 150, the log record is transmitted to the third terminal device 130 so that the information on the item A can be presented first.

Alternatively, information that compares the items searched by the consumer in the second zone 150 with items displayed in the third zone 160 may be displayed on the third terminal device 130, so that the information the user wants can be presented.

As described above, the process of analyzing the consumer's behavior pattern to provide information suiting the consumer's preference is carried out by storing the log record associated with the consumer's behavior in each of the zones.

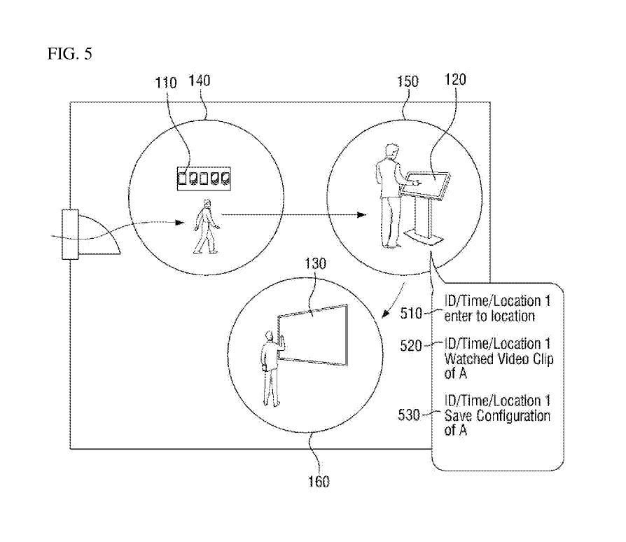

FIGS. 5 to 7 are views for illustrating a method for generating log records associated with consumers' behavior, sorting and storing them for each of the consumers, and generating a web page reflecting the consumer's preference based on it.

Specifically, FIGS. 5 to 7 illustrate a process of sequentially generating log records associated with consumers' behavior patterns in each of the zones to transmit them to the server, and sorting and storing them for each of the consumers by the server.

In FIG. 5, when a consumer carrying a first terminal device 110 enters a second zone 150, a first log record 510 is generated. Specifically, the first log record 510 may include the identifier of the first terminal device 110 issued to the consumer, a time when the log record is generated, the location of the consumer, and a message indicating that the consumer has entered the first zone 150 at the location.

Also, the consumer's behavior pattern may be generated using the second terminal device 120 installed in the second zone 150 as a log record to be transmitted to the server.

For example, if the consumer viewed a video clip relating to the item A on the second terminal device 120, a second log record 520 is generated, which includes a message indicating the consumer's behavior pattern, a message “watched video clip of A” in this example, as well as the identifier of the first terminal device 100 the consumer carries.

Likewise, a third log record 530 may be generated, which that indicates another behavior pattern entered via the second terminal device 120.

It is to be noted that the log record indicating the consumer's behavior pattern is not limited to that shown in FIG. 5, but may include and various behavior patterns that can be taken in the store.

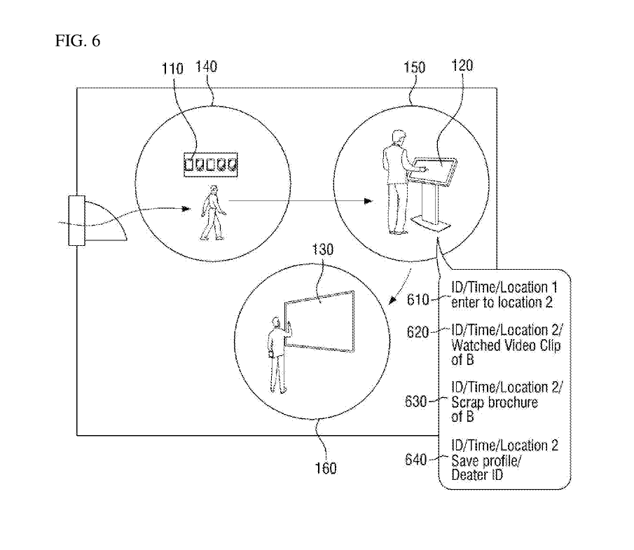

For example, as shown in FIG. 6, when a consumer inputs a query related to an item B or requests information on an item from a guide working in a store, information on the guide who provided the information to the consumer may be included in the log record.

Accordingly, if the consumer has an additional question about the item, the consumer can receive the information on the item again from the guide who has the history of consultation.

The log records thus generated are transmitted to the server, and then are sorted and stored for the respective folders.

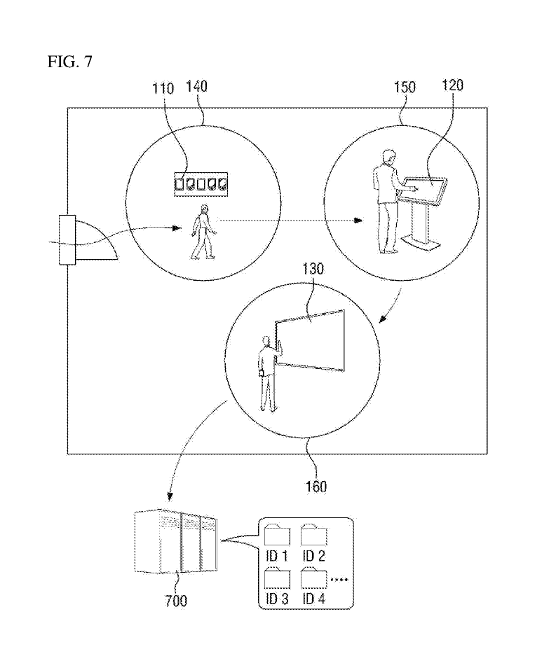

FIG. 7 is a view for illustrating a method for storing the generated log records in the server according to an exemplary embodiment of the present disclosure.

The log records thus generated include the identifier of the terminal device issued to the consumer. Accordingly, the log records transmitted to the server may be sorted by identifiers included in the log records and stored in the respective folders.

For example, if the identifier of the terminal device issued to a consumer is “xxx,” a folder corresponding to the identifier “xxx” of the terminal device is generated in the server. The log record indicating the consumer's behavior pattern in the store is stored in the folder corresponding to the identifier “xxx.”

That is, each folder generated in the server stores a log record indicating a consumer's behavior in the store.

Accordingly, upon receiving a request to generate a web page from the consumer corresponding to “xxx” identifier, the server may generate a web page using the log record previously stored in the folder in the server corresponding to the identifier “xxx,” to provide it to the consumer.

As described above, by issuing a terminal device to a consumer entering a store, generating a folder corresponding to the terminal device in a server, and then storing a log record indicating the consumer's behavior pattern in the store in the folder, it is possible to efficiently provide information on items suiting the consumer's preference.

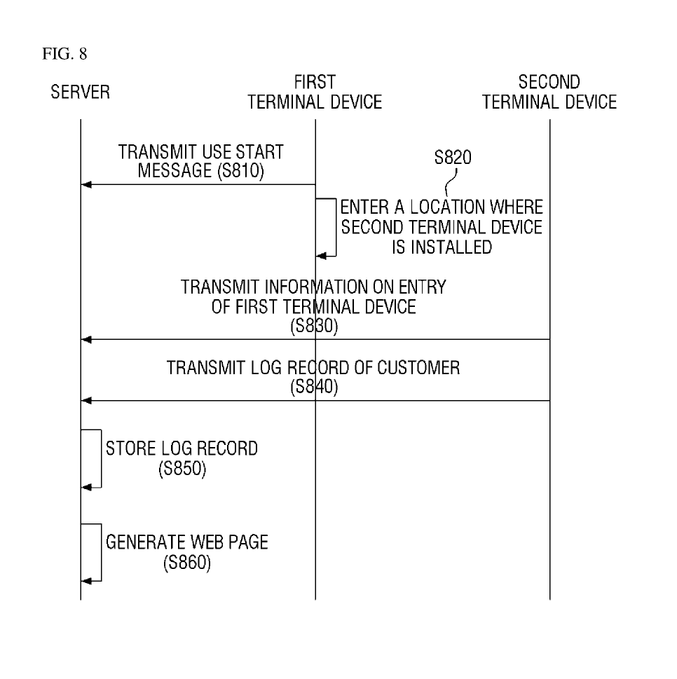

FIG. 8 is a flowchart for illustrating the above-described method for generating a web page based on a consumer's behavior pattern.

In this embodiment, the first terminal device 110 is issued to the consumer, and the second terminal device 120 is installed in a zone of the store, and the user searches for the information on items via the second terminal device 120.

It is to be noted that this is merely illustrative for convenience of illustration. In practice, a terminal device may be installed at each of a plurality of zones of the store, and a consumer's behavior pattern and log records associated therewith may be received from each terminal device.

When the first terminal device 110 is issued to the consumer, an initiation message of the first terminal device 110 is transmitted to the server (step S810). Specifically, the initiation message may include the identifier assigned to the first terminal device 110 and a message indicating the initiation.

Upon receiving the initiation message, the server may generate a folder corresponding to the identifier of the first terminal device 110 issued to the consumer in order to store the log record indicating the consumer's behavior pattern using the first terminal device 110.

Subsequently, when the consumer carrying the first terminal device 110 enters a zone of the store (step S820), a signal indicating that the consumer has entered the zone is transmitted to the server (step S830).

For example, a beacon may be installed in a zone of the store to recognize that a consumer carrying the first terminal device 110 has entered it, or a NFC (Near Field Communications) module or an RF (Radio Frequency) module may be mounted in the first terminal device 110, such that the consumer bring the first terminal device 110 into contact with the second terminal device 120 installed in a zone, thereby transmitting a signal indicating that the consumer has entered the zone to the server.

Subsequently, when the consumer searches for the information on items via the second terminal device 120 or inputs a query about the items or the like, a log record related thereto is transmitted to the server (step S840).

Upon receiving the log record relating to the consumer's behavior in the store, the server stores the received log record in the folder corresponding to the first terminal device 110 the consumer carries (step S850).

Subsequently, when a request to generate a web page is received from a consumer, the web page is generated using log records stored in the folder corresponding to the identifier included in request, and the generated web page is provided to the consumer.

As described above, by generating a web page based on the log record generated by the consumer, it is possible to efficiently provide information on the items that the consumer is interested in.

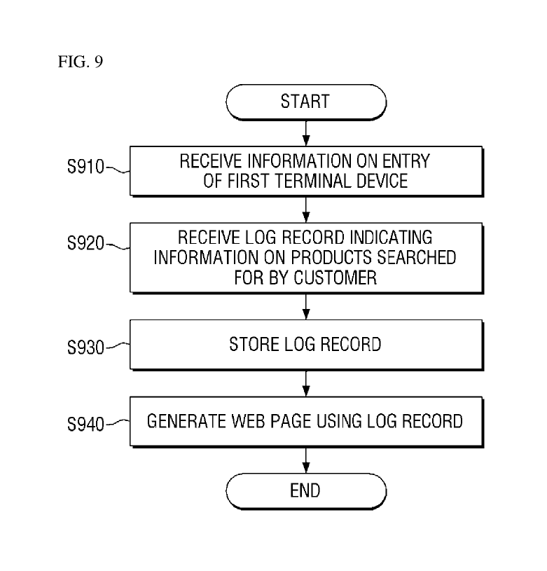

FIG. 9 is a flowchart for illustrating an operation for generating a web page by a server based on a consumer's behavior pattern according to an exemplary embodiment of the present disclosure.

The server receives a signal indicating that the consumer with the first terminal device 110 has entered a zone of the store where the second terminal device 120 is installed (step S910). Specifically, the server may receive the signal from the first terminal device 110 the consumer carries or from the second terminal device 120 installed in the zone of the store.

Subsequently, when the user takes an action such as searching for information on an item via the second terminal device 120 in the zone of the store, the log record related to the consumer's behavior pattern is received via the second terminal device 120 (step S920).

Since the log record includes the identifier assigned to the first terminal device 110, by analyzing the log record, it is possible to know the consumer's behavior pattern who has looked around the store.

The log record received by the server is stored in the folder corresponding to the identifier included in the log record (S930). Subsequently, when a request to generate a web page is received, the web page is generated using the log record (step S940).

For example, when the customer with the first terminal device 110 looks around the store and then come back to the information desk to bring the first terminal device 110 into contact with the manager's terminal device, the identifier assigned to the first terminal device 110 is transmitted to the manager's terminal device.

When the manager's terminal device sends a request to generate a web page to the server using the identifier, the server searches for the folder corresponding to the identifier and generates a web page using the log record stored in the folder.

The generated web page is provided to the manager's terminal device so that the user can check the information on items that she/he has looked around in the store at a glance. For example, the web page may include detailed information on the items that she/he looked around in the store, comparison information between the items and the like.

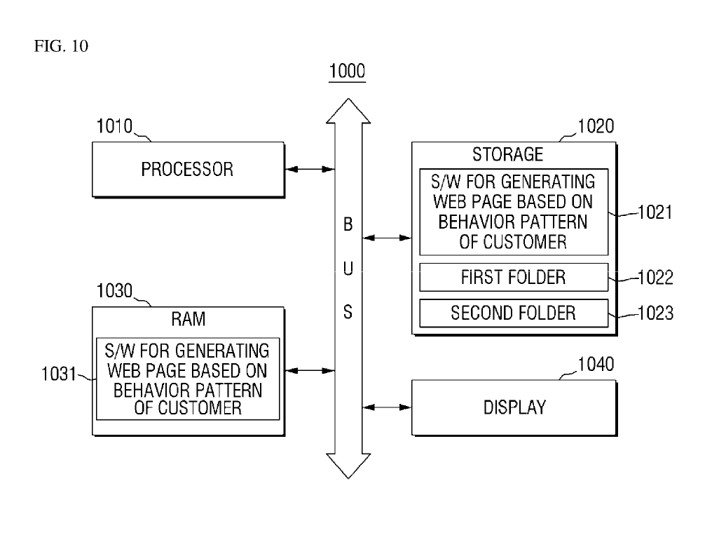

FIG. 10 is a functional block diagram for illustrating a server for generating a web page and providing it to a consumer according to the above-described embodiment.

The server 1000 shown in FIG. 10 includes one or more processors 1010, storage 1020, a memory 1030, and network interface 1040.

A program including operations of: receiving information indicating that a consumer carrying a first terminal device assigned an identifier has entered a zone of a store when the consumer entered the zone; receiving a log record associated with the consumer's behavior pattern via a second terminal device installed in a zone of the store; storing the log record in a folder corresponding to the identifier assigned to the first terminal device; and generating a web page based on the log record may be stored in the storage 1020. The program may be loaded into the memory 1030 and then may be performed by the processor 1010.

The above-described method may be implemented as a program that can be executed by a computer, and may be embodied in a computer-readable storage medium to be performed in a general-purpose digital computer that executes the program. In addition, the structure of the data used in the above-described method may be written on a computer-readable storage medium through various means. The computer-readable storage medium includes a storage medium such as a magnetic storage medium (e.g., a ROM, a floppy disk, a hard disk, etc.), and an optical recording medium (e.g., CD-ROM, a DVD, etc.).

It is to be understood that various modifications and changes may be made to the exemplary embodiments of the present disclosure without departing from the gist of the present disclosure. Therefore, the disclosed methods should be interpreted in an illustrative sense rather than a restrictive sense. The scope of the present disclosure is defined solely by the appended claims not by the foregoing description, and all modifications, equivalents and alternatives also fall within the scope of the present disclosure.

1. A method for generating a web page based on a behavior pattern of a consumer, the method comprising:
in response to the consumer entering a zone of a store while carrying a first terminal device assigned an identifier, receiving information indicating that the consumer has entered the zone;
receiving a log record associated with the behavior pattern of the consumer via a second terminal device installed in the zone of the store;
storing the log record in a folder corresponding to the identifier assigned to the first terminal device; and
generating a web page based on the log record.

2. The method of claim 1, wherein the receiving the information comprises:
receiving an entry information message comprising the identifier assigned to the first terminal device; and
generating the folder corresponding to the identifier.

3. The method of claim 2, wherein the entry information message comprises at least one from among the identifier assigned to the first terminal device, a time when the consumer carrying the first terminal device enters the zone of the store, and location information of the zone of the store.

4. The method of claim 1, wherein the log record associated with the behavior pattern of the consumer comprises the identifier assigned to the first terminal device carried by the consumer.

5. The method of claim 4, wherein the log record associated with the behavior pattern of the consumer comprises at least one from among information regarding items searched by the consumer via the second terminal device, a history of consulting by the consumer, a brochure opened by the consumer, an inquiry input by the consumer, and a profile of staff who consulted with the consumer.

6. The method of claim 4, wherein the storing the log record comprises:
searching for the folder corresponding to the identifier included in the log record; and
storing the log record in the folder corresponding to the identifier.

7. The method of claim 1, wherein the generating the web page comprises:
receiving a request to generate a web page including the identifier; and
generating the web page by using the log record stored in the folder corresponding to the identifier.

8. The method of claim 7, wherein the receiving the request comprises:
receiving the identifier from a terminal device of a manager, the identifier being transmitted as the first terminal device is brought into contact with the terminal device of the manager; and
generating a web page by using the log record stored in the folder corresponding to the identifier to provide the web page to the terminal device of the manager.

9. The method of claim 7, further comprising:
transmitting a uniform resource locator (URL) for accessing the generated web page to a mobile device of the consumer.

10. The method of claim 1, wherein the generating the web page comprises:
receiving the information from a third terminal device installed in the zone;
generating the web page based on the log record associated with the behavior pattern of the consumer received via the second terminal device; and
providing the generated web page to the third terminal device.

11. A server comprising:
at least one processor;
a memory configured to store instructions; and
storage configured to store at least one folder corresponding to an identifier assigned to a first terminal device carried by a consumer and a log record included in the folder,
wherein the instructions, when executed, cause the at least one processor to perform operations of:
in response to the consumer entering a zone of a store while carrying the first terminal device, receiving information indicating that the consumer has entered the zone;
receiving a log record associated with a behavior pattern of the consumer via a second terminal device installed in the zone of the store;
storing the log record in the at least one folder; and
generating a web page based on the log record.

12. A non-transitory computer-readable medium configured to store instructions which, when executed, cause a computing device to perform operations of:
in response to a consumer entering a zone of a store while carrying a first terminal device assigned an identifier, receiving information indicating that the consumer has entered the zone;
receiving a log record associated with a behavior pattern of the consumer via a second terminal device installed in a zone of the store;
storing the log record in a folder corresponding to the identifier assigned to the first terminal device; and
generating a web page based on the log record.

13. A system for generating a web page based on a consumer's behavior pattern, the system comprising:
a first terminal device assigned an identifier and issued to a consumer;
a second terminal device installed in a zone of a store; and
a server configured to receive a log record from the second terminal device and to generate a web page,
wherein the second terminal device is configured to transmit information indicating that the consumer carrying the first terminal device has entered a zone in response to the consumer entering the zone, and to transmit the log record associated with the consumer's behavior pattern to the server, and
wherein the server is configured to store the received log record in a folder corresponding to the identifier assigned to the first terminal device, and to generate a web page based on the stored log record.
